(19) United States
(12) Patent Application Publication
(10) Pub. No.: US 2007/0228683 A1
(43) Pub. Date: Oct. 4, 2007

(54) Retrofit rear independent suspension for all terrain vehicles

(76) Inventor: Andrew Ciasulli, Easton, PA (US)

Correspondence Address: PLEVY, HOWARD & DARCY, P.C., P.O. BOX 226, Fort Washington, PA, 19034, US

(21) Appl. No.: 11/728,588

(22) Filed: Mar. 26, 2007

Related U.S. Application Data
(60) Provisional application No. 60/785,635, filed on Mar. 24, 2006.

(51) Int. Cl. B60G 9/00

(52) U.S. Cl. 280/124.1

(57) ABSTRACT

A retrofit independent suspension system for an all terrain vehicle (ATV) includes a sub-frame having a mounting point adapted to connect to the existing swing-arm mount of the ATV and a linkage member connected to the sub-frame on one end and adapted to connect to the existing rear upper shock mount of the ATV. A connecting member is pivotably connected on each side of the sub-frame. An upright is pivotably connected to each of the two connecting members. An axle is rotatably connected on each side of the sub-frame at one end, and is rotatably connected to an upright on other end. A wheel hub is rotatably connected to each of the two axles. A mounting point is connected on each side of the sub-frame, which is adapted to receive one end of a shock absorbing element.

### RELATED APPLICATION

This application claims priority of U.S. Patent Application Ser. No. 60/785,635, entitled INDEPENDENT REAR SUSPENSION CONVERSION FOR ALL TERRAIN VEHICLES, filed Mar. 24, 2006, the entire disclosure of which is hereby incorporated by reference as if being set forth in its entirety herein.

### FIELD OF THE INVENTION

The present invention relates generally to all terrain vehicles (ATVs) and more particularly to the conversion of an ATV with non-independent rear suspension system into an ATV with an independent rear suspension.

### BACKGROUND OF THE INVENTION

All terrain vehicles (ATVs) are often used to cross terrains where most other conventional vehicles cannot be used. Sport models of ATVs have been built with focus on performance, for example racing, and other recreational uses . . . . Many of these ATVs use a swing-arm rear suspension system. Some of the disadvantages of such a non-independent rear suspension include reduced stability at higher speeds, loss of traction when one wheel hits a bump and the other does not, reduced overall traction, and relatively lower ground clearances.

### SUMMARY OF THE INVENTION

In an embodiment of the invention, a retrofit independent rear suspension (IRS) system for an all terrain vehicle (ATV) includes a sub-frame which has a mounting point adapted to connect to the swing-arm mount of the ATV. The system further includes a linkage member connected to the sub-frame on one end and adapted to connect to the rear upper shock mount of the ATV. First and second connecting members are pivotably connected on each side of the sub-frame. First and second uprights are pivotably connected to the first and second connecting members respectively. First and second axles are rotatably connected at one end on the first and second sides of the sub-frame respectively. At the other end, the first and second axles are rotatably connected to the first and second uprights respectively. The system further includes first and second wheel hubs rotatably connected to the first and second axles respectively. The sub-frame further includes second and third mounting points each of which are adapted to receive one end of a shock absorber.

Another embodiment of the present invention includes a method for converting an ATV with non-independent rear suspension into an ATV with independent rear suspension (IRS). The method includes the steps of removing the rear swing-arm, linkage, brake caliper and the chain from the ATV and connecting an IRS sub-frame to the swing-arm mount of the ATV. A further step is connecting a linkage member to the IRS sub-frame at one end and at the other end connecting the linkage member to the rear upper shock mount of the ATV. The method includes further steps of mounting the brake caliper on a brake caliper mount on the IRS sub-frame and mounting a chain on the drive sprocket on the IRS sub-frame.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts and in which:

FIG. 1 illustrates a rear view of an independent rear suspension system as per an embodiment of the invention;

FIG. 2 shows a perspective view of some of the parts of the independent rear suspension system, as per an embodiment of the invention;

FIG. 3 is a side perspective view of an IRS sub-frame, as per an embodiment of the invention;

FIG. 4 is another side perspective view of the IRS sub-frame of FIG. 3;

FIG. 5 is a front perspective view of the IRS sub-frame of FIG. 3;

FIG. 6 is a front perspective view of an independent rear suspension system showing some of the major components, according to an embodiment of the invention;

FIG. 7 illustrates a rear view of a prior art ATV with a non-independent rear suspension system;

FIG. 8 illustrates another rear perspective view of the prior art ATV of FIG. 7.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical rear suspension systems. However, because such elements are well known in the art, and because they do not facilitate a better understanding of the present invention, a discussion of such elements is not provided herein. Examples of such known elements which are not described are bearings used to connect the wheel hubs to the drive axles and flanges used to connect the inner constant velocity joints to drive sprocket and brake disc. The disclosure herein is directed to all such variations and modifications known to those skilled in the art.

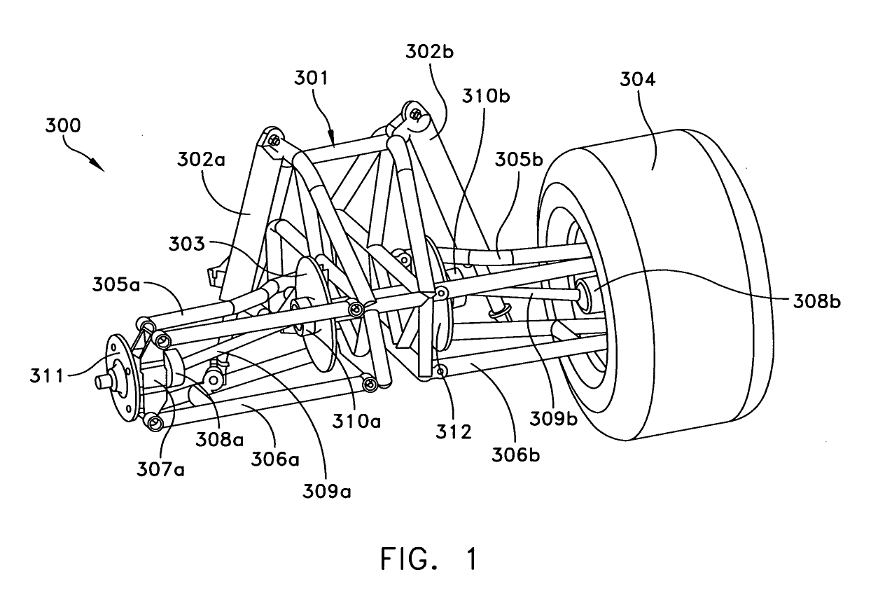

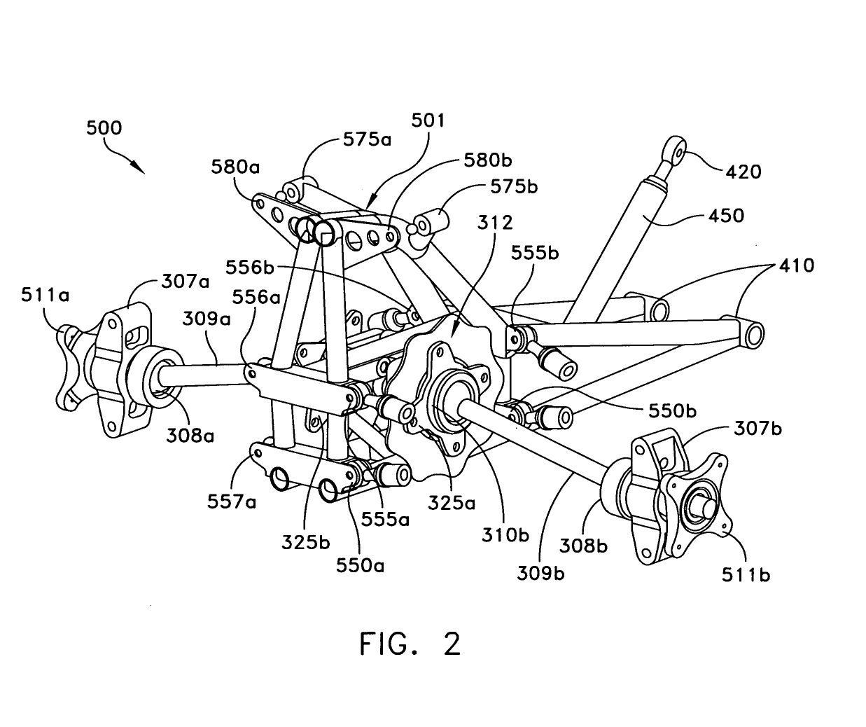

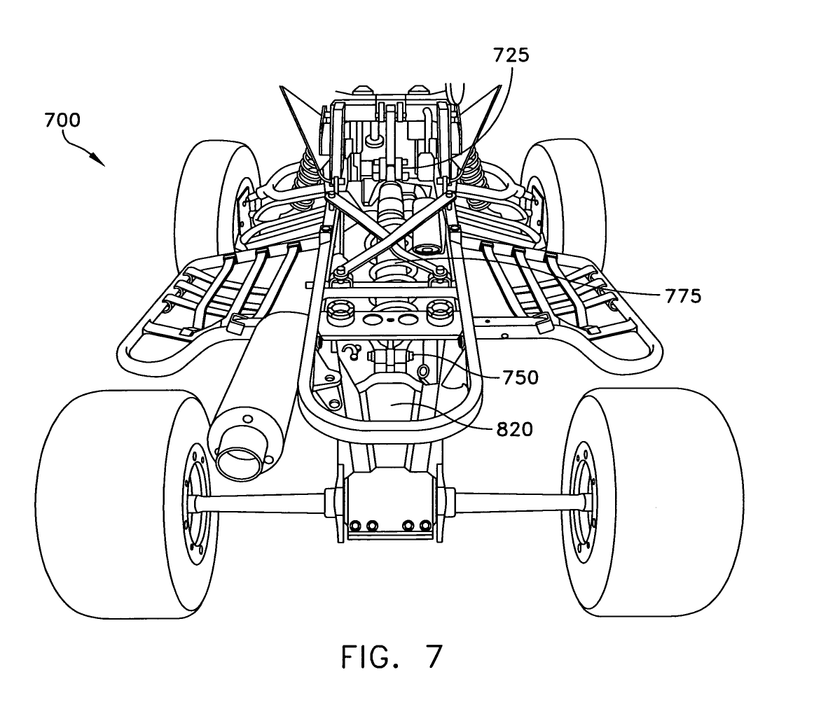

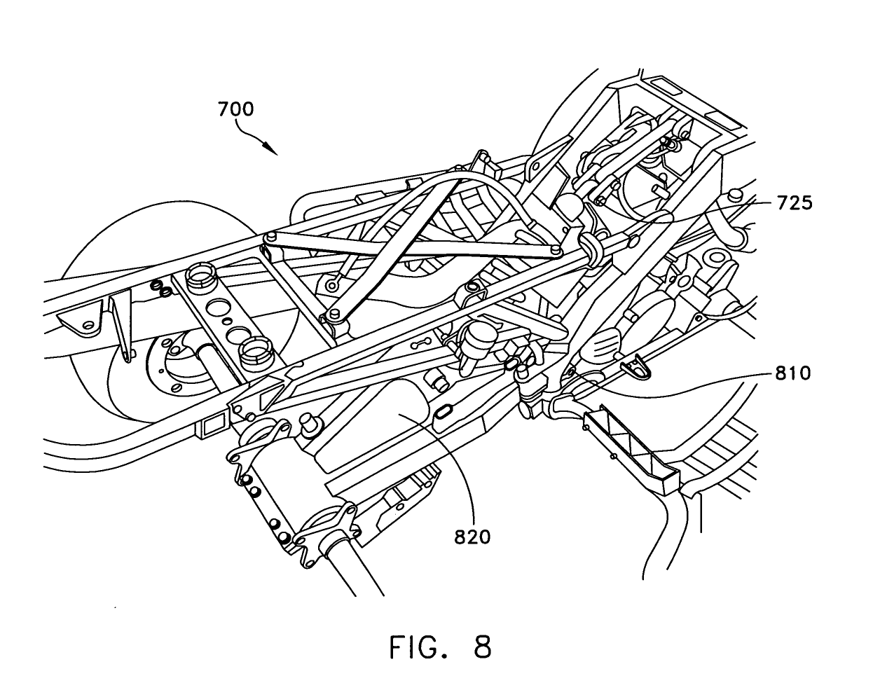

Now referring to FIGS. 1 and 2, an independent rear suspension (IRS) system 300 for an ATV is illustrated. The IRS system 300 includes a sub-frame 301. The sub-frame 301 is attachable to a conventional ATV (700 of FIG. 7) at the upper rear shock mount (725 of FIGS. 7 and 8) and the swing-arm mounts (810 of FIG. 8) on the ATV (700 of FIG. 7). In the illustrated embodiment best shown in FIG. 2, the sub-frame 301 has two mounting points: upper mount 420 and lower mount 410. In an exemplary configuration, the upper mount 420 can be connected to an existing rear upper shock mount (725 of FIGS. 7 and 8) of the ATV (700 of FIG. 7) and the lower mounts 410 can be connected to an existing swing arm mount (810 of FIG. 8) of the ATV (700 of FIG. 7). Tabular weld on mounts as well as manufactured clamp-on mounts may also be used to connect the IRS sub-frame to the ATV frame. Bolts and other such known means may be used to connect the sub-frame 301 to the ATV frame.

In the illustrated embodiment best shown in FIG. 1, the IRS system 300 utilizes a dual A-arm suspension system and includes two upper A-arms 305ₐ and 305_{b} and two lower A-arms 306ₐ and 306_{b}. At one end, each of the two upper A-arms 305ₐ and 305_{b} and each of the two lower A-arms 306ₐ and 306_{b} are pivotably connected to the mounting points 555ₐ and 555_{b}, and 550ₐ and 550_{b}, (see FIG. 2) on one side and the mounting points 556ₐ and 556_{b}, and 557ₐ and corresponding mounting point (not shown) on the other side of the sub-frame 301. At the other end, the upper A-arm 305ₐ and the lower A-arm 306ₐ (see FIG. 1) are pivotably connected to an upright 307ₐ, while the upper A-arm 305_{b} and the lower A-arm 306_{b} are connected to another upright 307_{b} (FIG. 2). Since the uprights 307ₐ and 307_{b} and the A-arms 305ₐ, 305_{b}, 306ₐ, and 306_{b} are pivotably connected, the uprights 307ₐ and 307_{b} can translate along an arc defined by the dual A-arms 305ₐ and 306ₐ and 305_{b} and 306_{b} respectively, pivoting about their respective mounting points on the sub-frame 301.

The IRS system 300 further includes two shock absorber and spring assemblies 302ₐ and 302_{b} as seen in FIG. 1. Such shock absorber and spring assemblies are known in the art. At one end, the assemblies 302ₐ and 302_{b} are connected to their respective mounting points 575ₐ and 580ₐ (FIG. 2) on one side and the mounting points 575_{b} and 580_{b} on the other side of the sub-frame 301. In the exemplary embodiment, the assemblies 302ₐ and 302_{b} are connected, at the other end, to the lower A-arms 306ₐ and 306_{b} respectively. The assemblies 302ₐ and 302_{b} suspend the ATV and provide damping while the ATV is motion. It is to be understood that shock absorber and spring assemblies are described only in an exemplary fashion. Other shock absorbing elements as understood by one skilled in the art may be utilized.

Still referring to FIGS. 1 and 2, two inner constant velocity joints 310ₐ and 310_{b} are connected on either side of the sub-frame 301. Two flanges 325ₐ and 325_{b} are connected to the inner constant velocity joints 310ₐ and 310_{b} respectively. A drive sprocket 303 and a brake disc 312 are attached to the flanges 325_{b} and 325ₐ respectively, one on each side of the sub-frame 301. Such drive sprockets and brake discs are well-known in the art. As is known in the art, drive sprockets are used to transmit power from the ATV engine to the rear wheels using one or more drive chains. In the illustrated embodiment, a half axle 309ₐ is rotatably connected to the drive sprocket 303 through the inner constant velocity joint 310_{b}, whereas another half axle 309_{b} is rotatably connected to the brake disc 312 through the inner constant velocity joint 310ₐ. A wheel hub 311 is rotatably connected to the half axle 309ₐ through an outer constant velocity joint 308ₐ, whereas another wheel hub (not shown) is similarly rotatably connected to the half axle 309_{b} through another outer constant velocity joint 308_{b}. The wheel hubs may be bolted to the outer constant velocity joints, as is well-known to those skilled in the art. Such inner and outer constant velocity joints are also well-known in the art, and therefore, are not described in further detail. In FIG. 1, a wheel 304 is shown attached to a wheel hub. Similarly, another wheel may be attached to the wheel hub 311.

Now referring to FIG. 2, two mounting points 555ₐ and 555_{b} are used to connect the upper A-arm to an IRS sub-frame 501. Similarly, two mounting points 550ₐ and 550_{b} are used to connect the lower A-arm to the IRS sub-frame 501. An inner constant velocity joint 510 is clearly visible as are two outer constant velocity joints 560ₐ and 560_{b}. A linkage bar 450 is used to connect the IRS sub-frame 501 to the ATV's existing rear upper shock mount (725 of FIG. 7) (as opposed to the ATV's rear lower shock mount 750 of FIG. 7). The linkage bar 450 is connected to the IRS sub-frame 501 at one end to a mounting point 710 (FIG. 7). In an exemplary embodiment, the linkage bar may be pivotably connected to the IRS sub-frame 501 which allows for a change in its angle relative to the sub-frame 501. This flexibility makes the IRS system suitable for various ATVs having different configurations. At the other end, the linkage bar 450 is connected to the rear upper shock mount (725 of FIG. 7) of the ATV (700 of FIG. 7). The linkage bar 450 provides added strength and rigidity to the sub-frame 501 and stops swinging motion of the sub-frame 501, when the ATV is in motion.

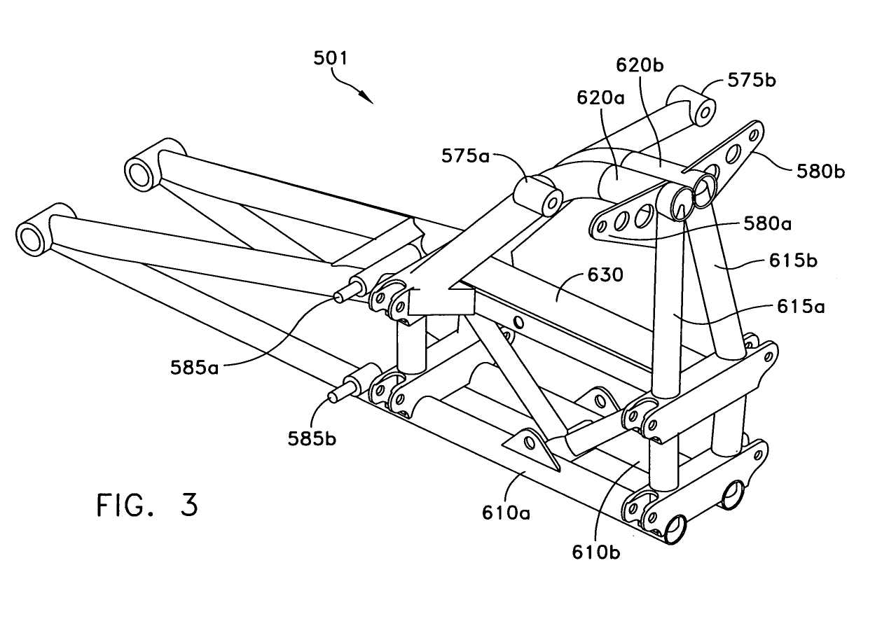

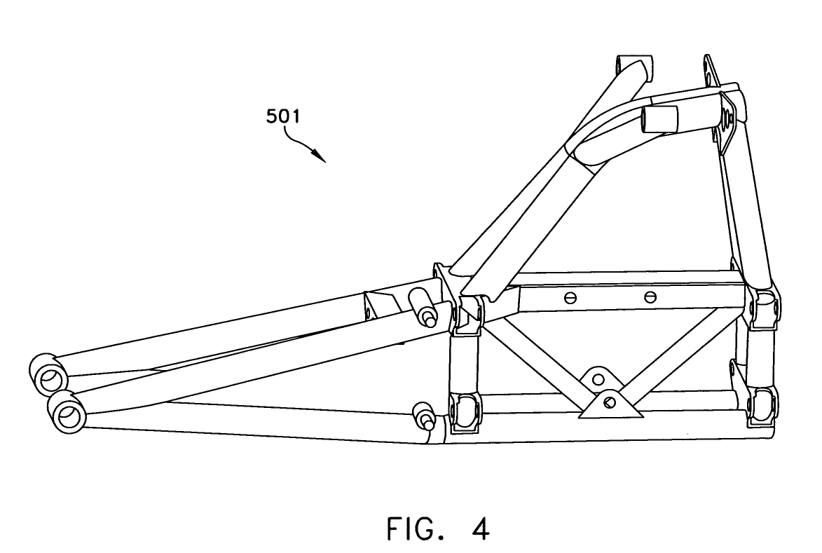

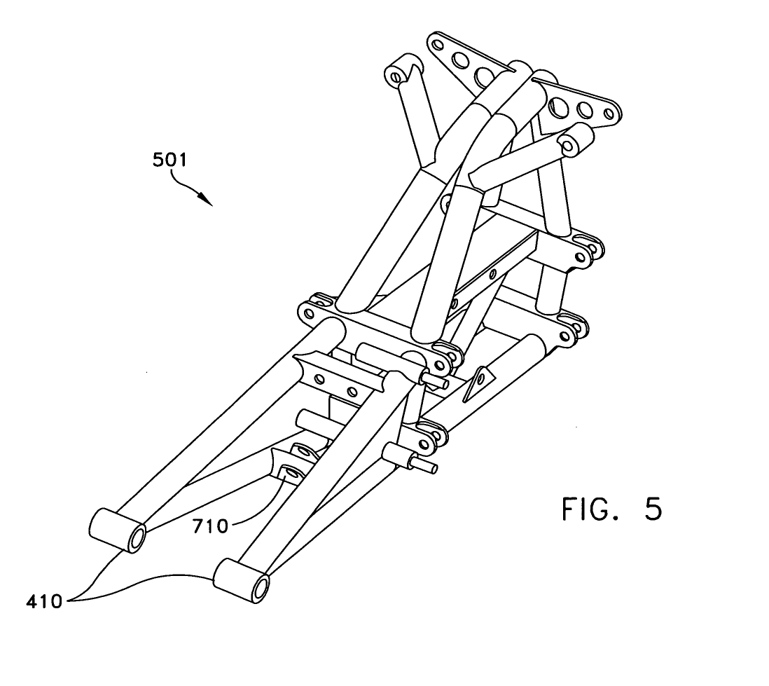

An IRS sub-frame 501 is illustrated in FIGS. 3, 4, and 5. Two mounting points 575ₐ and 575_{b} in conjunction with parts 580ₐ and 580_{b} are used to connect the shock absorber and spring assemblies 302ₐ and 302_{b} to the sub-frame 501 at one end. Two longitudinal structural members 610ₐ and 610_{b} provide support and structural rigidity to the sub-frame 501. In the illustrated embodiment, the two longitudinal structural members 610ₐ and 610_{b} are round hollow tubes. Structural members of other cross-sectional shapes, whether hollow or solid, are also contemplated to be within the scope of the present invention. Other structural members include 615ₐ, 615_{b}, 620ₐ, and 620_{b}. All the structural members 610ₐ, 610_{b}, 615ₐ, 615_{b}, 620ₐ, and 620_{b} are connected to each other using known techniques such as welding. Member 630 also provides support and structural rigidity to the sub-frame 501 and supports the installation of the drive sprocket 303, brake disc 312, and the inner constant velocity joints 310ₐ and 310_{b}. Brake caliper mounts (not shown) may be bolted or otherwise connected to the member 630 as well. A brake caliper mount is a plate like member which is used to mount the brake calipers. Different ATVs may have different types of brake calipers; hence the size and the shape of the brake caliper mount may also be different. Correspondingly the member 630 may be adapted to receive brake caliper mount of the desired size and shape. Two bolt like structures 585ₐ and 585_{b} are visible in FIG. 3, for example. These two bolt-like structures 585ₐ and 585_{b} receive chain rollers (not shown). These chain rollers guide the drive chain above and below the A-arms and prevent the drive chain from coming in contact with the upper and the lower A-arms. Such chain rollers are well-known in the art, and hence for brevity, will not be further discussed in detail.

It will be understood that the illustrated sub-frame is only exemplary. Other sub-frame structures which accommodate at least one connection to an ATV frame and which support the drive sprocket and the brake disc along with the related connections to the half axles as well as the shock absorber and spring assemblies are also contemplated to be within the scope of the present invention.

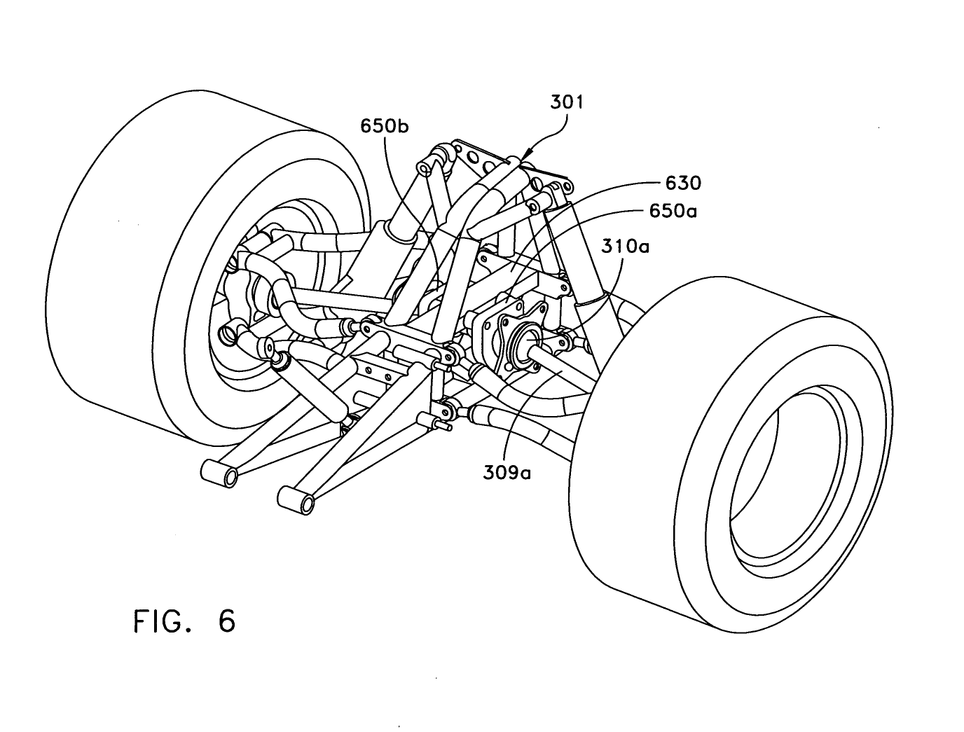

Referring now to FIG. 6, major components of the retrofit rear independent suspension system according to an embodiment of the invention are illustrated. Like reference numerals represent like components from other drawings. A bearings and pillowblock assembly 650ₐ is used to connect the inner constant velocity joint 310ₐ to the member 630 of the IRS sub-frame 301. Similarly, another bearings and pillowblock assembly 650_{b} is used to connect the other inner constant velocity joint 310_{b} to the member 630 of the IRS sub-frame 301. Such bearings and pillowblock assemblies are well known in the art. Spacers may be used between the assemblies and the IRS sub-frame to ensure proper positioning of these pillowblock assemblies.

Now a method of installing an IRS as per an embodiment of the invention and thereby converting an ATV with a non-independent rear suspension system into an ATV with an independent rear suspension system will be described. An exemplary prior art ATV with a non-independent rear suspension system is illustrated in FIGS. 7-8. The rear swing-arm 820, which pivots or swings about rear swing-arm mount 810 (FIG. 8), the rear central linkage 775, which may include a shock absorber and spring assembly, the break caliper and the drive chain are removed from the ATV, using the methods known in the art. The lower mounting points 410 of the IRS subframe (see e.g. 510 of FIG. 2) are aligned with and connected to the ATV's swing-arm mount 810. Spacers (not shown) may be used between the lower mounting points 410 and the ATV's swing-arm mount 810 to ensure a proper fit, as is known in the art. The linkage bar 450 is mounted on the upper shock mount 725 of the ATV 700 such that the IRS sub-frame 301 has substantially the same ground clearance as that of the ATV frame. Proper clearances should be maintained between the IRS sub-frame 301 and the ATV air-box (not shown). Depending on the type of ATV, length of the linkage bar 450 may need length adjustments, which can be achieved by rotating the linkage bar and tightening the jam nuts or other such fastening members, as will be understood by a person skilled in the art.

The original brake calipers are then mounted onto the brake caliper mount, which may be bolted to the IRS sub-frame 301, so that the brake disc can slide through the brake caliper and can be stopped by applying brake pressure. The ATV chain is mounted on the drive sprocket 303. Depending on the type of the ATV, the length of the chain may have to be adjusted. Chain length adjustment may include known steps of cutting the chain to obtain a proper length and proper tautness once mounted on the drive sprocket 303. Wheels can then be mounted on the wheel hubs 511ₐ and 511_{b}. Once the wheels have been mounted, shock absorber and spring assemblies 302ₐ and 302_{b} are mounted between the mounting points 575ₐ and 580ₐ and the mounting points 575_{b} and 580_{b} on the upper ends respectively. At the lower ends, the assemblies 302ₐ and 302_{b} are mounted on lower A-arms 306ₐ and 306_{b} respectively.

It will be apparent to those skilled in the art that modifications and variations may be made in the apparatus and process of the present invention without departing from the spirit or scope of the invention. It is intended that the present invention cover the modification and variations of this invention provided they come within the scope of the appended claims and their equivalents.

What is claimed is:

1. A retrofit independent suspension system for an all terrain vehicle (ATV), said suspension system comprising:
a sub-frame, said sub-frame having a first mounting point adapted to connect to the swing-arm mount of the ATV;
a linkage member, said linkage member connected to said sub-frame on one end and adapted to connect to the upper rear shock mount of the ATV;
first and second connecting members pivotably connected on a first and a second side of said sub-frame respectively;
first and second uprights pivotably connected to each of said first and second connecting members respectively;
first and second axles rotatably connected on first and second sides of said sub-frame at one end respectively, said first and second axles rotatably connected to said first and second uprights on the other end respectively;
first and second wheel hubs rotatably connected to each of said first and second axles respectively; and
second and third mounting points on each side of said sub-frame, each of said second and third mounting points adapted to receive one end of a shock absorbing element.

2. The retrofit independent suspension system according to claim 1, wherein said first and second connecting members comprise:
first and second A-arms on said first side of said sub-frame; and
third and fourth A-arms on said second side of said sub-frame.

3. The retrofit independent suspension system according to claim 2, wherein said second and fourth A-arms are adapted to receive the second end of the shock absorbing element.

4. The retrofit independent suspension system according to claim 1, said system further comprising:
a drive sprocket rotatably connected to said sub-frame; and
a brake disc rotatably connected to said sub-frame.

5. The retrofit independent suspension system according to claim 4, wherein said first axle is rotatably connected to said drive sprocket and said second axle is rotatably connected to said brake disc.

6. The retrofit independent suspension system according to claim 5, wherein said first and second axles are rotatably connected to said drive sprocket and said brake disc through constant velocity joints.

7. The retrofit independent suspension system according to claim 1, wherein said first and second uprights are connected to said first and second axles through constant velocity joints.

8. The retrofit independent suspension system according to claim 1, wherein said shock absorbing element comprises a shock absorber and a spring assembly.

9. The retrofit independent suspension system according to claim 1, wherein said first mounting point on said sub-frame is adapted to be bolted onto the swing-arm mount of the ATV.

10. The retrofit independent suspension system according to claim 1, wherein said linkage member is adapted to be bolted onto the rear upper shock mount of the ATV.

11. The retrofit independent suspension system according to claim 1, further comprising a spacer between said first mounting point on said sub-frame and said swing-arm amount of the ATV.

12. The retrofit independent suspension system according to claim 1, wherein said linkage member is pivotably connected to said sub-frame.

13. A method of retrofitting an all terrain vehicle (ATV) with an independent suspension system, the ATV having a rear upper shock mount, a rear swing-arm mount, a rear swing-arm, a linkage, a shock absorber, a brake caliper mount, a brake caliper and a chain, said method comprising the steps of:
removing the rear swing-arm, the rear central linkage, the brake caliper, the brake caliper mount and the chain from the ATV;
connecting an Independent Rear Suspension (IRS) sub-frame to the swing-arm mount of the ATV;
connecting a linkage member at one end to the IRS sub-frame and at the other end to the ATV rear upper shock mount;
mounting the brake caliper to a brake caliper mount on the IRS sub-frame; and
mounting the chain to a drive sprocket on the IRS sub-frame.

14. The method of claim 13, wherein the step of connecting an IRS sub-frame to the swing-arm mount of the ATV comprises the step of inserting a spacer between a mounting point on the IRS sub-frame and the swing-arm mount of the ATV.

15. The method of claim 13, further comprising the step of adjusting the length of said linkage member by rotating said linkage member and by tightening fasteners provided along said linkage member.
